(19) United States
(12) Patent Application Publication
(10) Pub. No.: US 2008/0144113 A1
(43) Pub. Date: Jun. 19, 2008

(54) DITHERING METHOD AND APPARATUS FOR IMAGE DATA

(75) Inventor: TSUNG-MING CHEN, TAIPEI (TW)

Correspondence Address: ROSENBERG, KLEIN & LEE, 3458 ELLICOTT CENTER DRIVE-SUITE 101, ELLICOTT CITY, MD, 21043, US

(73) Assignee: VIA TECHNOLOGIES, INC., TAIPEI (TW)

(21) Appl. No.: 11/670,618

(22) Filed: Feb. 2, 2007

(30) Foreign Application Priority Data
Oct. 18, 2006 (TW) 95138375

(51) Int. Cl. G06K 15/00

(52) U.S. Cl. 358/3.13

(57) ABSTRACT

A dithering method and apparatus are disclosed for image data. At least two different weighting numbers are provided, and the sequence characteristic of the current frame is determined. One of the weighting numbers is then selected as the effective weighting number according to the sequence characteristic. After comparing at least one least significant bit (LSB) of the image data with the effective weighting number, at least one most significant bit (MSB) of the image data is adjusted according to the comparing result.

### BACKGROUND OF THE INVENTION

1. Field of the Invention

The present invention relates to an image processing method and apparatus, and more particularly to an image data dithering method and apparatus for a flat panel display.

2. Description of the Prior Art

A portable computer, such as a notebook, generally contains a flat panel display. A typical example of a flat panel display is a liquid crystal display (LCD). As shown in FIG. 1A, the conventional LCD 10 receives and converts image data output from the computer graphic adapter 12 into video signals which can then be displayed as meaningful content to a user. The output format of the image data of the computer graphic adapter 12 typically includes 24 bits in which three 8-bit digital data are respectively used to represent the primary red(R), green(G), and blue(B) colors. The LCD 10 of most notebooks, however, can only accept 18-bit image data as input in which the three primary colors are respectively represented by 6-bit digital data. Thus, the output image data of the notebook graphic adapter 12 must be transformed by a converter 14 before can be input to and displayed by the LCD 10.

An immediate way to convert the image data from 24-bit to 18-bit is to truncate the two least significant bits (LSBs) of each primary color. Truncating the two LSBs leads to sacrificing some resolution as well as sensible visual defects in some content, such as loss of the continuity or fluency, so that the overall LCD image quality is downgraded. An image processing technique called “dithering” is generally used to resolve such problem and improve the average performance and visual effect. The dithering method carries or truncates a number of LSBs to keep the average color intensities of the original image and mitigate the visual defects. The truncation of LSBs reduces the color intensities. Accordingly, the dithering technique will compensate such loss of brightness or color intensities by adding a carry to the six most significant bits for some pixels.

FIG. 1B shows the dithering pattern array of a conventional dithering method. Digits outside the array denote the horizontal coordinates (X) and vertical coordinates (Y) of image data, while digits in the array refer to the weighting numbers used by the dithering process. In the illustrated conventional dithering mechanism, a plurality of 2×2 dithering pattern arrays 30 are applied to the digital image data frame in an adjacent and non-overlapping style horizontally and vertically. Only the four 2×2 dithering pattern arrays 30 corresponding to the 4×4 pixels with the smallest coordinates (X and Y) have been shown in FIG. 1B. All pixels in the same frame will correspond to the 2×2 dithering pattern arrays 30 in aforementioned adjacent and non-overlapping style. Each entry of the dithering pattern array 30 corresponds to a pixel. The number in each entry represents a weighting number used by the dithering method to determine if the two LSBs of the color components of the corresponding pixel are to be truncated off or carried to the remaining most significant bits (MSBs). As described above, each color component is represented by an 8-bit digital data. If the value represented by the two LSBs of a color is greater than or equal to the weighting number of the corresponding entry of the dithering pattern array, the output of the dithering process will be set to the remaining six MSBs plus 1, i.e., the six MSBs added by the dithering carry; on the contrary, if the value of the two LSBs is less than the corresponding weighting number, the output of the dithering process will be set to the original six MSBs, in other words, the two LSBs are truncated in this case.

In the following description, the notation BIT[i:j] of a byte denotes the numeric value represented by the binary pattern composed of bit i to bit j in the byte. For example, BIT[1:0] means the value represented by bit 1 to bit 0 (i.e., the two LSBs), and BIT[7:2] means the value represented by the binary pattern of bit 7 to bit 2 (i.e., the six MSBs). Referring to FIG. 1B, the weighting number in location (0,0) is 0, thus the color components of the pixel in location (0,0) will always be carried, i.e., the output of the dithering process is BIT[7:2]+1. The weighting number in location (1,0) is 3, thus if BIT[1:0] of the pixel color in location (1,0) is greater than or equal to 3, then the dithering output will be BIT[7:2]+1, otherwise the dithering output is simply BIT[7:2]. The rest may be deduced by analogy.

While the foregoing conventional dithering method may alleviate some visual defects after image conversion, the average color intensity is still degraded after such dithering process. Furthermore, some specific image content will suffer from a fixed distortion problem in such conventional dithering process. As a result, there exists a current need for an improved dithering method and apparatus that are capable of maintaining average color intensity as well as resolving the fixed distortion problem.

### SUMMARY OF THE INVENTION

The present invention provides an improved dithering method and apparatus which achieve better average color intensity and resolve the fixed distortion problem in conventional technique.

In general, an image data dithering method is set forth in accordance with the present invention. In accordance with an embodiment of the present invention, at least two different weighting numbers are provided, and the sequence characteristic of the current frame is determined. Accordingly, one of the weighting numbers is selected to be the effective weighting number according to the sequence characteristic. After comparing at least one least significant bit (LSB) of the image data with the effective weighting number, at least one most significant bit (MSB) of the image data is adjusted according to the comparing result.

In accordance with another embodiment of the present invention, an image data dithering apparatus is set forth. The apparatus includes a selection element, a comparison element, and a bit-adjusting element. The selection element selects one of at least two different weighting number as an effective weighting number according to the sequence characteristic of the current frame. The comparison element compares at least one LSB of the image input data with the effective weighting number. The bit-adjusting element adjusts at least one MSB of the image input data according to the comparison result of the comparison element.

### BRIEF DESCRIPTION OF THE DRAWINGS

FIG. 1A shows a block diagram comprising a conventional liquid crystal display, a computer graphic adapter and a converter therebetween.

FIG. 1B shows a dithering pattern array used by the conventional dithering method.

FIG. 2 shows a block diagram illustrating the connection among a graphic adapter, a display and the dithering apparatus in accordance with an embodiment of the present invention.

FIG. 3A and FIG. 3B illustrate the dithering pattern weighting arrays used by the dithering apparatus of FIG. 2.

FIG. 4 shows the detailed internal block diagram of the dithering apparatus of FIG. 1.

FIG. 5 shows the flow diagram of the dithering method corresponding to the apparatus of FIG. 4.

### DETAILED DESCRIPTION OF THE INVENTION

FIG. 2 shows a system diagram including a dithering apparatus 100 in accordance with an embodiment of the present invention. As shown in FIG. 2, the dithering apparatus 100 receives an image input data DI from the graphic adapter 102, and then applies different dithering pattern to the image input data DI according to some frame sequence characteristics (such as counting of the vertical synchronous signal VSYNC). The output image data DO is output to the display 104 (such as an LCD). As shown in the figure of the current embodiment, the dithering apparatus 100 is separated from the graphic adapter 102 and the display 104. In other embodiment in accordance with the present invention, the dithering apparatus 100, however, may be located in the display 104, the graphic adapter 102, or other portion of a computer.

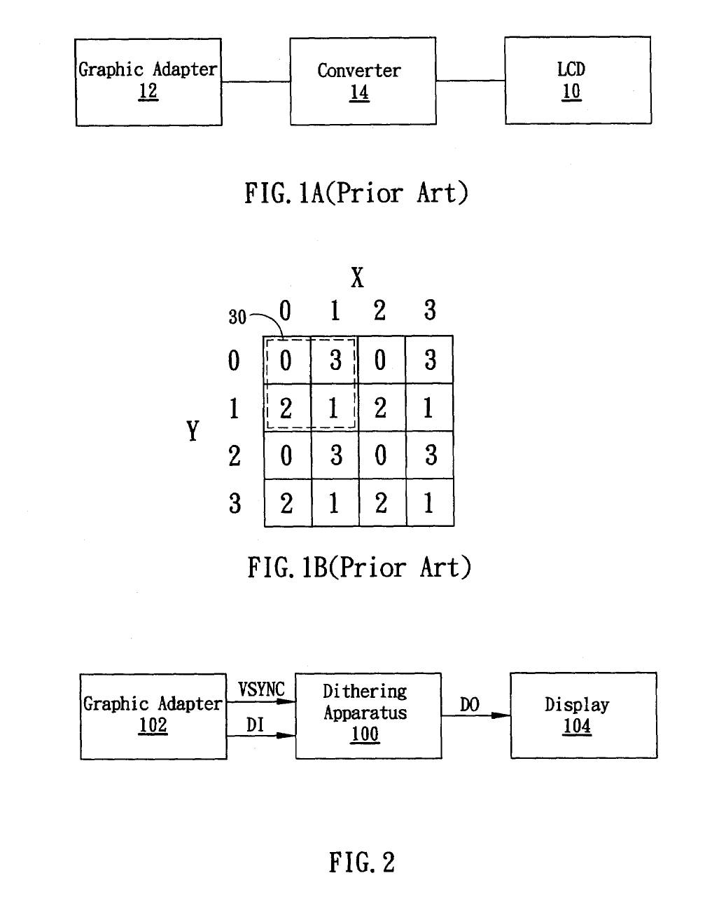

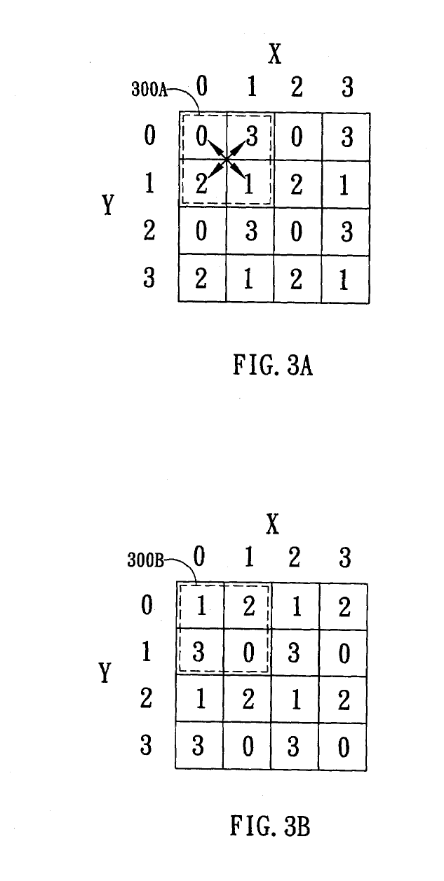

FIG. 3A and FIG. 3B shows the dithering pattern weighting arrays used by the dithering apparatus 100 of FIG. 2. For clarity, as described in FIG. 1B, only four 2×2 dithering pattern arrays (300A, 300B) are respectively shown in FIG. 3A and FIG. 3B, which are corresponding to the 4×4 pixels with smallest coordinates in the digital image frame. In addition, the process illustrated in following description can be applied to any color component of a pixel. The dithering patterns shown in FIG. 3A and FIG. 3B are respectively applied to the frames with odd sequence numbers (or the odd frames) and the frames with even sequence numbers (or the even frames). It should be noted that even and odd are interchangeable, in other words, the overall effect will be identical if the dithering pattern of FIG. 3B is applied to odd frames while the dithering pattern of FIG. 3A is applied to even frames. The dithering pattern of FIG. 3A is different from that of FIG. 3B. In this embodiment, the 2×2 dithering pattern array 300B of FIG. 3B can be derived by a centro-mirrored transformation from the 2×2 dithering pattern array 300A of FIG. 3A. For example, let M(x,y) denote the value of the entry (x,y) in an array M, if two 2×2 arrays M1 and M2 are centro-mirrored to each other, then M1(0,0) equals M2(1,1), M1(0,1) equals M2(1,0), M1(1,0) equals M2(0,1), and M1(1,1) equals M2(0,0). The transformation between the two dithering pattern arrays is not limit to the centro-mirrored manner as described in this embodiment. Other types of transformation may be applicable to the present invention. One aspect of the embodiment of the present invention is to dynamically alter the dithering pattern according to the frame sequence, and thereby the average color intensity of surrounding pixels can be maintained. In this embodiment, the determination of odd frame or even frame is through monitoring the vertical synchronous signal, for example, counting the frame sequence numbers by a counter or a flip-flop (recording the least significant bit will be sufficient to determine even or odd). Moreover, the content of the dithering pattern array (300A, 300B) may be stored in a programmable register or created by a segment of logic code in a run-time manner. The detail of the dithering method and apparatus in accordance with the present invention will now be described accompanying with the attached drawings.

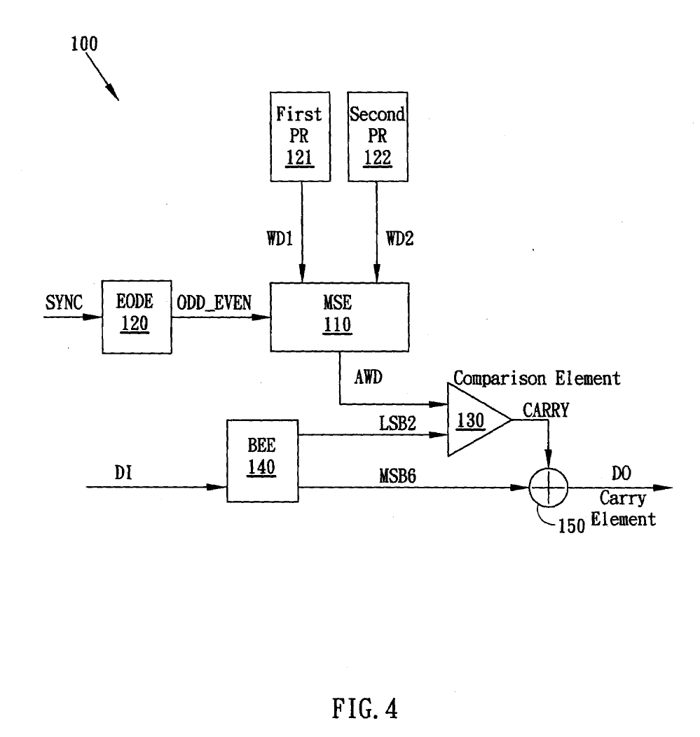

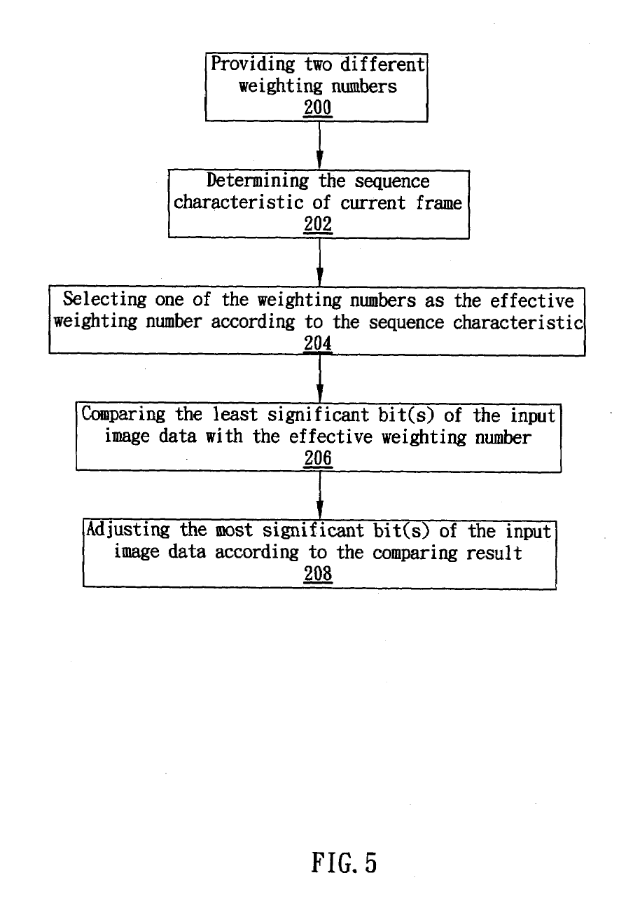

FIG. 4 shows the detailed internal block diagram of the dithering apparatus 100 of FIG. 1, in which the illustrated blocks can be implemented by hardware circuits, software procedures, or the combination thereof. FIG. 5 shows the flow diagram of the dithering method corresponding to the apparatus of FIG. 4. The execution order of the illustrated steps of FIG. 5 may be interchanged, and some of them may be executed concurrently. The dithering apparatus 100 includes a multiplexing selection element (MSE) 110, an even/odd determination element (EODE) 120, a first programmable register (first PR) 121, a second programmable register (second PR) 122, a comparison element 130, a bit extraction element (BEE) 140 and a carry element 150. While a single dithering apparatus 100 may be sufficient to serially process four image data with the 2×2 dithering pattern array (300A,300B), in practice, however, a plurality of (e.g. four) dithering apparatuses 100 may be employed to concurrently process four image data with the 2×2 dithering pattern array (300A,300B), so as to enhance the performance.

To begin with, two different weighting numbers are provided (step 200). In this embodiment, the first programmable register 121 and the second programmable register 122 respectively provide the stored first weighting number WD1 and the second weighting number WD2, which are respectively corresponding to the weighting numbers in the even frame dithering pattern array and the odd frame dithering pattern array. Also regarding to FIG. 3A and FIG. 3B, if the stored number in the first programmable register 121 is 0 (respectively 1,2,3), then the stored number in the second programmable register 122 will be 1 (respectively 0,3,2). In this embodiment, the difference between the weighting numbers stored in the first programmable register 121 and the second programmable register 122 is 1. Nevertheless, such difference is not a limit to the present invention. In other embodiments, if the first weighting number WD1 and the second weighting number WD2 are created in run-time by any external or internal module, then the first programmable register 121 and the second programmable register 122 may be removed.

Then, the sequence characteristic of the current frame is determined (step 202). In this embodiment, the even/odd determination element 120 (such as a counter or a flip-flop) provides the frame even/odd signal ODD_EVEN according to the video vertical synchronous signal VSYNC. For example, current frame is an even frame when the LSB of the output data of the counter is 0; on the contrary, current frame is an odd frame when the LSB of the output data of the counter is 1. In this embodiment, the sequence of the even/odd signal ODD_EVEN is (even, odd, even, odd, . . . ). The sequence may also be (even, even, odd, odd, . . . ) in other embodiments.

In step 204, one of the weighting numbers WD1 and WD2 is selected as the effective weighting AWD according the sequence characteristic (such as even frame or odd frame). In this embodiment, the multiplexing selection element 1 10 (such as a 2 by 1 multiplexer) selects one of the two-bit first weighting number WD1 and the second weighting number WD2 according to the frame even/odd signal ODD_EVEN and outputs a two-bit effective weighting number AWD. In particular, the multiplexing selection element 110 selects the first weighting number WD1 (respectively the second weighting number WD2) as the effective weighting number AWD when the frame even/odd signal ODD_EVEN is 0 (respectively 1).

In step 206, some least significant bits LSB2 of the input image data DI are compared with the effective weighting number AWD. In this embodiment, the input image data DI is separated into a two-bit least significant portion LSB2 and a six-bit most significant portion MSB6 by the bit extraction element 140. The input image data DI is not limit to be separated into a two-bit portion and a six-bit portion in other embodiments. The bit extraction element 140 shown in FIG. 4 is for illustration only. In practice, the bit extraction element 140 may be omitted and respective bit lines may be directly connected to input terminals of respective elements (130,150). The comparison element 130 (such as a comparator) then compares the effective weighting number AWD output from the multiplexing selection element 110 with the two-bit least significant portion LSB2 of the input image data DI.

If the two-bit least significant portion LSB2 is greater than or equal to the effective weighting number AWD, then a carry signal CARRY is asserted and output to the carry element 150. If the carry element 150 receives an asserted carry signal CARRY, then the output data DO will be equal to the most significant portion MSB6 added with a carry (MSB6+1) in step 208, otherwise, the output image data Do will be equal to the original six-bit most significant portion MSB6. The carry element 150 may be an adder. In this embodiment, if the least significant portion LSB2 is greater than or equal to the effective weighting number AWD, then the most significant portion MSB6 is adjusted by adding a carry. In other embodiments, different adjustment, such as adding a number other than one, may be adopted.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A dithering method for image data, comprising steps of:
providing at least two weighting numbers;
determining a sequence characteristic of a current frame;
selecting one of the weighting numbers as an effective weighting number according to the sequence characteristic;
comparing at least one least significant bit (LSB) of the image data with the effective weighting number; and
adjusting at least one most significant bit (MSB) of the image data according to result of the comparing step.

2. The dithering method of claim 1, wherein the at least two weighting numbers comprise two sequences of weighting numbers respectively corresponding to two dithering pattern arrays.

3. The dithering method of claim 2, wherein each of the dithering pattern arrays is centro-mirrored to the other one.

4. The dithering method of claim 1, wherein the sequence characteristic distinguishes the current frame as an even frame or an odd frame.

5. The dithering method of claim 4, wherein the even frame or the odd frame re determined according to a video vertical synchronous signal.

6. The dithering method of claim 1, wherein a carry is generated if the at least one least significant bit of the image data is greater than the effective weighting number in the comparing step and the adjusting step.

7. The dithering method of claim 6, wherein the carry is added to the at least one most significant bit of the image data in the adjusting step.

8. A dithering apparatus for image data, comprising:
a selection element, selecting one of at least two weighting numbers as an effective weighting number according to a sequence characteristic of a current frame;
a comparison element, comparing at least one least significant bit of the image data with the effective weighting number; and
a bit-adjusting element, adjusting at least one most significant bit of the image data according to a comparing result of the comparison element.

9. The dithering apparatus of claim 8, further comprising at least two programmable registers for outputting and storing the at least two weighting numbers.

10. The dithering apparatus of claim 8, wherein the sequence characteristic distinguishes the current frame as an even frame or an odd frame.

11. The dithering apparatus of claim 10, further comprising an even/odd determination element which determines the even frame or the odd frame according to a video vertical synchronous signal.

12. The dithering apparatus of claim 11, wherein the even/odd determination element is a counter or a flip-flop.

13. The dithering apparatus of claim 8, wherein the selection element is a multiplexer.

14. The dithering apparatus of claim 8, further comprising a bit extraction element which separates the image data into the at least one least significant bit and the at least one most significant bit.

15. The dithering apparatus of claim 8, wherein the at least two weighting numbers comprise two sequences of weighting numbers respectively corresponding to two dithering pattern arrays input to the selection element.

16. The dithering apparatus of claim 15, wherein each of the dithering pattern arrays is centro-mirrored to the other one.

17. The dithering apparatus of claim 8, wherein the comparison element receives the at least one least significant bit of the image data and the effective weighting number, and generates a carry if the at least one least significant bit of the image data is greater than the effective weighting number.

18. The dithering apparatus of claim 8, wherein the comparison element is a comparator.

19. The dithering apparatus of claim 17, wherein the bit-adjusting element receives the at least one most significant bit of the image data and the carry, so as to add the carry to the at least one most significant bit of the image data.

20. The dithering apparatus of claim 8, wherein the bit-adjusting element is an adder.
